(19) United States
(12) Patent Application Publication
(10) Pub. No.: US 2002/0139235 A1
(43) Pub. Date: Oct. 3, 2002

(54) Singulation apparatus and method for manufacturing semiconductors

(76) Inventors: Brett William Nordin, Chandler, AZ (US); James Joseph McDonald, Peoria, AZ (US)

Correspondence Address: MERCHANT & GOULD PC, P.O. BOX 2903, MINNEAPOLIS, MN, 55402-0903, US

(21) Appl. No.: 10/081,919

(22) Filed: Feb. 20, 2002

Related U.S. Application Data
(60) Provisional application No. 60/270,073, filed on Feb. 20, 2001.

(51) Int. Cl. B26D 3/08

(52) U.S. Cl. 83/886; 83/861; 83/876; 83/880; 83/13

(57) ABSTRACT

A method and apparatus are provided for singulating semiconductor devices from a strip containing a plurality of semiconductor devices. A singulation saw chuck is also provided. The method includes the steps of making isolation cuts part way through the strip of semiconductor devices, inverting the strip onto a saw chuck with barriers that mate with the isolation cuts, and making singulation cuts that match the isolation cuts to completely separate the individual semiconductor devices.

### BACKGROUND OF THE INVENTION

1. Field of the Invention

This invention relates to an apparatus and method for singulating semiconductor devices.

2. Brief Description of the Art

Various types of integrated circuit devices have evolved since the development of the semiconductor. Such semiconductor devices have innumerable applications in industry and commerce. In the manufacture of semiconductor devices, it is known to first create a strip, which constitutes an integral unit containing numerous semiconductor devices within the strip. For example, a strip of semiconductor devices may have 40, 80, 100 or 1000 semiconductor devices contained within the strip. For use, the individual semiconductor devices must be separated, or singulated from the strip. Once the strip has been singulated into individual semiconductor devices, the semiconductor devices are sorted and transferred to various locations for further processing.

Semiconductors are often packaged as Chip Scale Packages, or CSPs. A CSP is defined as a microelectronic package that has an outline dimension 1.2 times greater than the outside dimension of the associated integrated circuit. CSPs have experienced rapid growth in recent years due to the heavy demand for portable and handheld communication devices. CSPs push the envelope of packaging technology to achieve a cost effective, small, light and high performance way to interconnect, test and protect integrated circuits. CSP assembly requires maintaining tighter manufacturing tolerances, processing new materials and using small part handling methods.

With automation now being implemented in today's semiconductor manufacturing facilities, capital and material costs pose the greatest cost savings opportunity. For advanced assembly capacity to be cost effective it must be highly utilized (uptime) and it must process more product (units per hour). The greatest unit density has been achieved by processing units in tightly packed arrays on a single piece metal leadframe or organic layered substrate. To accommodate the increase in density, equipment tooling and processing methods have evolved. Previously, units were molded individually and singulated from the leadframe or substrate by mechanical punching. In an array format, an entire “panel” is molded. The panel may consist of hundreds of devices that must be singulated from the panel for use in the end application. The method of singulation that has been widely embraced is sawing, using a resin bond diamond or metal wheel.

Sawing of panel molded CSPs has typically been performed by adhering the leadframe or organic layered substrate to tape, such as mylar, and cutting in a manner conventional to wafer sawing. The tape serves to secure the units during the sawing process and oppose the violent forces caused by the mechanical erosion of the saw blade. The use of mylar tape, however, doesn't lend itself to automated methods of handling the singulated units at high speeds, reducing the cost effectiveness. Also, in a high volume production environment where cycle time and cost are a concern, tape creates additional processing steps and uses consumable materials. Additionally, cutting through an adhesive tape reduces the life of the cutting blade because the adhesive binds to the blade.

One method of reducing damage to the cutting blade is to pull the tape away from the semiconductor devices to be cut using a vacuum, as disclosed in U.S. Pat. No. 6,112,740. While this method avoids cutting through the adhesive tape, tape is still used to hold the semiconductors in place, requiring mechanical means or chemical solvents to remove the semiconductors from the tape after cutting.

To eliminate the use of tape, panel form sawing was adopted. This technique uses vacuum provided by the sawing equipment to secure the units during the sawing process. Panel form sawing uses a metal interface plate or “chuck” that physically mounts to the saw table. The saw provides vacuum that secures the molded panel to the chuck. The chuck typically has a compliant rubber material on the top surface to provide compliance and improve the vacuum integrity between the molded panel and the chuck. The vacuum is applied to the molded panel through a series of holes in the saw chuck. The hole pattern generally matches the layout of the singulated units in the panel, providing a single vacuum hole for each unit. When the four sides of the unit have been cut, the unit is considered to be singulated. Once singulated, the unit remains secured to the chuck, under vacuum, until the entire panel has been sawn and either the unit or chuck is removed from the saw. Panel form sawing does have several challenges that do not exist in a tape-mounted process. When a unit becomes singulated, the forces from the saw blade can pull a unit from the chuck, scrapping product during the process. This phenomenon is more prevalent in metal leadframe based products due to metal smearing and burring.

U.S. Pat. No. 5,803,797 discloses a method of cutting semiconductors using vacuum to hold the semiconductors on the cutting chuck. While this method avoids the problems associated with using tape, the vacuum must be maintained during transport in order to keep the semiconductors in place on the chuck. Additionally, the vacuum pressure that secures the semiconductor devices during cutting decreases as the size of the semiconductor device and its associated vacuum hole decreases. The decrease in vacuum often allows the semiconductor devices to fly off the saw chuck during the final saw blade pass.

What is needed is a method and apparatus for singulating semiconductor devices that is accurate, fast, precise, does not involve tape mounting, and securely holds the semiconductors in place for singulation and transport.

### SUMMARY OF THE INVENTION

The present invention provides methods and apparatus for singulating semiconductor devices from a panel containing multiple semiconductor devices. In one embodiment, a method is provided for singulating semiconductor devices which involves performing isolation cuts followed by singulation cuts on a strip of semiconductor devices. The isolation cuts are made between individual semiconductor devices and extend part way through the strip. The strip is then inverted onto a saw chuck having at least one upwardly extending barrier. In one embodiment, the saw chuck has multiple vacuum apertures, and the barriers are located adjacent the apertures. The strip is positioned so the barriers mate with the isolation cuts and the semiconductor devices are positioned over the vacuum apertures. The barriers are of a height such that they do not extend all the way into the isolation cuts. A vacuum is activated and singulation cuts are made directly above and into the isolation cuts to achieve singulation of the individual semiconductor devices.

Pursuant to another embodiment of the present invention, a saw chuck for holding a strip of semiconductor devices is provided. The saw chuck has a plurality of vacuum apertures and a plurality of upwardly extending barriers adjacent each aperture. The barriers may be pins or walls. In a particular embodiment, the vacuum apertures are arranged in a grid of columns and rows, with each aperture positioned in a separate grid square. In another embodiment, the barriers are cross-shaped walls positioned at the corners of grid squares. In a further embodiment, the barriers are L-shaped walls. Embodiments are also provided in which the walls extend part way along grid lines or the entire length of the grid lines. A further embodiment provides a layer of compliant material on the top surface of the saw chuck.

In a further embodiment, the semiconductors are tested after the isolation cuts are made. Additionally, the semiconductor devices may be marked with test results and/or location after they are tested.

The present invention also provides an apparatus for singulating semiconductor devices manufactured in a strip. The apparatus involves a support member for holding a strip of semiconductor devices, a transfer mechanism for inverting and moving the strip of semiconductor devices, a saw chuck with multiple vacuum apertures and barriers adjacent each aperture, and a cutting mechanism. In one embodiment, the apparatus also involves a testing device and a marking device.

### BRIEF DESCRIPTION OF THE DRAWINGS

FIG. 1 is a perspective view of one embodiment of a saw chuck in accordance with the principles of the present invention.

FIGS. 2-6 are top views of various embodiment of the saw chuck in accordance with the principles of the present invention.

FIG. 7 is a partial cross-sectional view of a strip of semiconductor devices during the isolation cut step of the semiconductor device singulation method.

FIG. 8 is a partial cross-sectional view of a strip of semiconductor devices during the testing step of the semiconductor device singulation method.

FIG. 9 is a partial cross-sectional view of a strip of semiconductor devices during the marking step of the semiconductor device singulation method.

FIG. 10 is a partial cross-sectional view of a strip of semiconductor devices on one embodiment of a saw chuck during the singulation step of the semiconductor device singulation method.

FIG. 11 is a partial cross-sectional view of a strip of semiconductor devices on an alternative embodiment of a saw chuck during the singulation step of the semiconductor device singulation method.

FIG. 12 is a partial cross-sectional view of singulated semiconductor devices on one embodiment of a saw chuck during transfer from the singulation saw to a sorting device.

FIG. 13 is a partial cross-sectional view of singulated semiconductor devices on one embodiment of a saw chuck placed on a sorting device.

FIG. 14 is a cross-sectional view of a singulated semiconductor device being removed from the saw chuck by a sorting device.

### DETAILED DESCRIPTION OF THE INVENTION

It is to be understood that the figures have been simplified to illustrate only those aspects of the saw chuck and singulation apparatus that are relevant for a clear understanding of the present invention, while eliminating, for the purpose of clarity, other elements which may be found in typical saw chucks and singulation devices. Those of ordinary skill in the art will recognize that other elements may be desired or required to produce operational saw chucks and singulation devices. However, because such elements are well known in the art, and because they do not further aid in the understanding of the present invention, a discussion of such elements is not described herein. All numerical values are presumed modified by the term “about”.

Semiconductor devices are often manufactured in strips, with a plurality of devices generally arranged in a grid format with constant distance between the semiconductor devices on the strip. During processing of the semiconductor devices, the semiconductor strip is cut into individual pieces to separate or singulate each individual semiconductor device for further processing. Saws are often used to cut the strips of semiconductor devices. Alternative cutting mechanisms including lasers, water jets, or other apparatus that will be apparent to one of ordinary skill in the art upon reading this disclosure.

Lasers of various types have been deployed to cut metal and organic materials in semiconductor applications. A higher power laser is typically required to cut a metal material when compared to an organic material. The mismatch in power poses a problem for cutting semiconductor devices that are composed of both metal and organics such as mold compound. For a metal leadframe encapsulated with organic molding compound, a laser deployed for singulation requires enough power to cut through both the metal leadframe and molding compound materials. Lasers of this type tend to be slow and expensive.

By using the methods of isolation by sawing, one can eliminate the metal and reduce the thickness of the molding compound that is required to be cut by the laser. A commercially available Nd: YAG diode pump laser is deployed to rapidly complete the cutting process of thin molding compound, in lieu of deploying a saw to perform the singulation process. The isolation cut depth can be increased to accommodate lower laser powers and faster cut rates without affecting the functionality of the strip. The remaining material thickness in the isolated areas could range from 0.015 to 0.005 inches.

The laser erodes the relatively thin molding compound that remains after isolation cutting and strip test, without the aggressive forces created by a saw singulation process. This makes laser cutting very advantageous for small parts where vacuum pressure is limited by the hole size in the chuck carrier. As in the method described for saw singulation, the isolated strip is placed in the chuck carrier with the barriers extending into the isolation cut areas. The laser then completes the cut while the individual semiconductors are safely secured under vacuum and captured by the barriers of the chuck. Another advantage to the laser process is that the vacuum can be greatly reduced, compared to saw singulation, due to the non-aggressive nature of the laser cutting process. The chuck becomes critical for precisely locating the strip relative to the laser and for securing the singulated semiconductor devices during transport.

The present saw chuck and semiconductor device singulation apparatus are designed to cut strips of semiconductor devices into individual semiconductor devices and to retain them in a form corresponding to their original location on the semiconductor device strip.

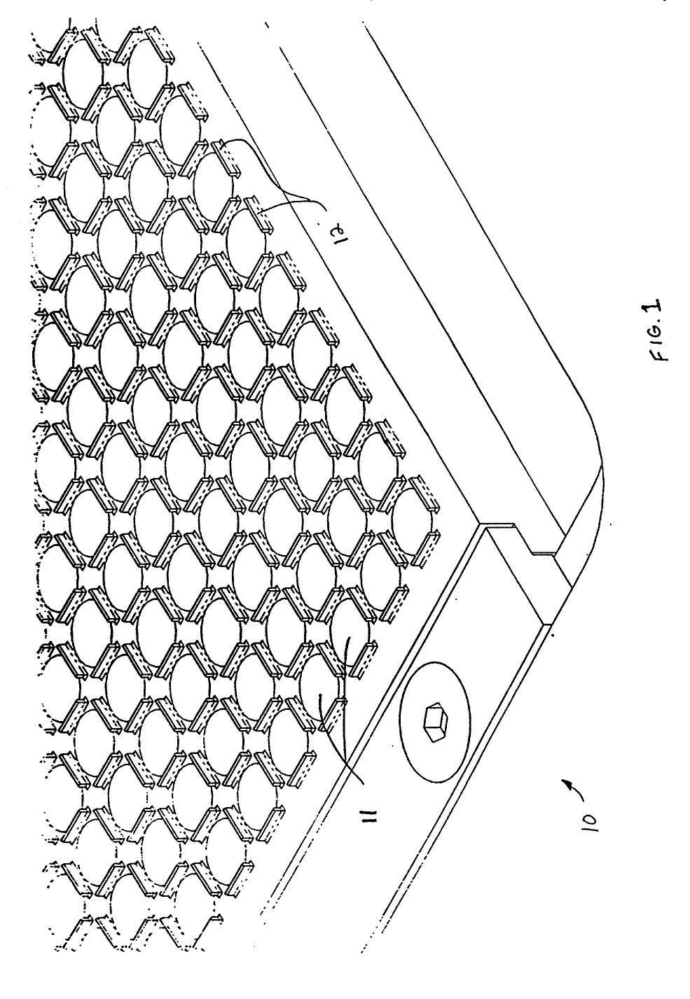

FIG. 1 shows one embodiment of a singulation saw chuck 10 according to the present invention. The saw chuck 10 has multiple vacuum apertures 11 extending through the chuck. Adjacent the vacuum apertures are upwardly extending barriers 12. The barriers 12 are constructed and arranged to mate with isolation cuts 27 in a strip of semiconductor devices 20. The barriers 12 may take the form of walls, pins or other retaining structures that will be apparent to one of ordinary skill in the art upon reading this disclosure.

The barriers 12 can be positioned on at least two sides of each vacuum aperture 11. In one embodiment, the vacuum apertures 11 are arranged in a grid of columns and rows, corresponding to the grid arrangement of the semiconductor devices on a strip such that each semiconductor device is positioned over a single vacuum aperture 11. The barriers 12 are generally positioned along lines separating the rows and columns of the grid of vacuum apertures 11.

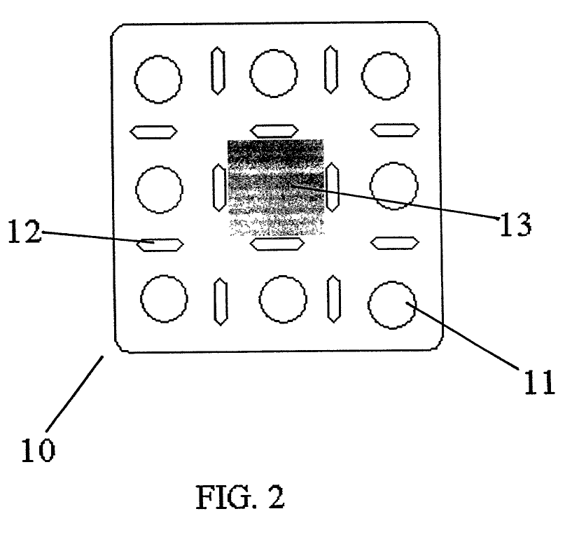

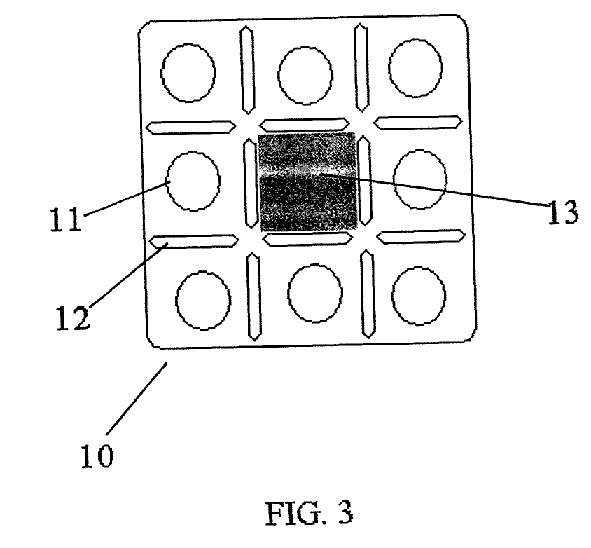

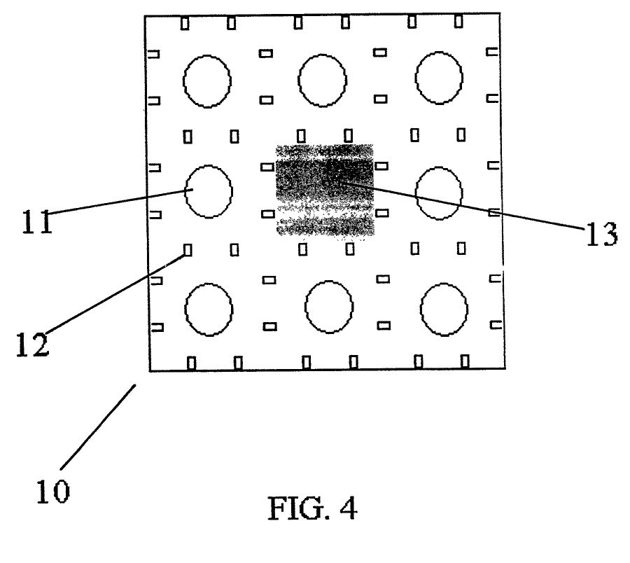

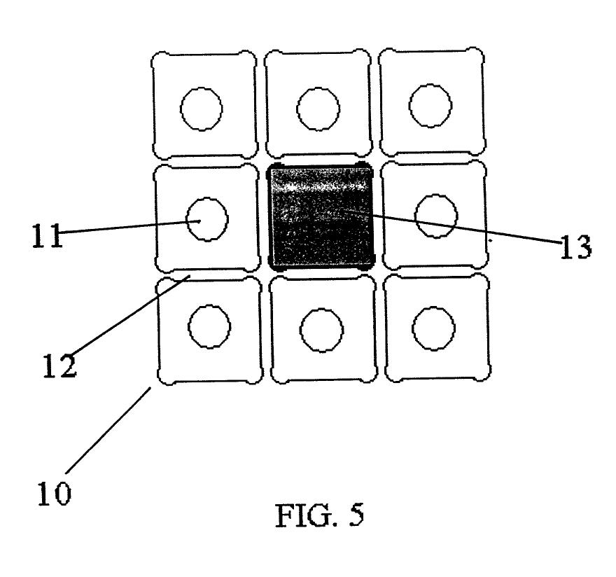

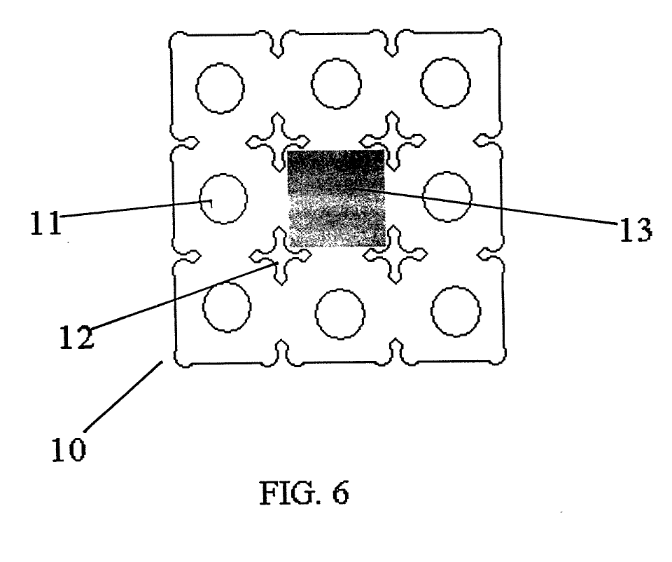

FIGS. 2-6 illustrate various barrier 12, 112, 212, 312, 412 configurations on the singulation saw chuck 10 according to the present invention. FIGS. 2 and 3 illustrate embodiments in which the barriers 12, 112 are walls extending part way along the grid lines between vacuum apertures 11. A single semiconductor device 13 is shown on saw chuck 10 for reference. In an alternative embodiment, shown in FIG. 4, the barriers are pins 212. One or more pins are located along the grid lines. In another embodiment, the barriers are continuous walls 312 extending the full length of the grid lines, completely surrounding each vacuum aperture 1, as shown in FIG. 5. In a further embodiment, the barriers are cross-shaped walls 412 positioned at the junction of grid rows and columns, as illustrated in FIG. 6. In a still further embodiment, the barriers can be “L” shaped walls positioned at opposite corners of a grid square containing a vacuum aperture 11. The grid of vacuum apertures and barriers can be in the form of rectangles to accommodate rectangular shaped semiconductor devices. It will be apparent to one of ordinary skill in the art, upon reading this disclosure, that the vacuum apertures and barriers may be placed in various arrangements to accommodate various shaped semiconductors. The height of the barriers 12 is generally at least 0.001 inches less than the depth of the isolation cuts. This allows a singulation cut 10 to intersect the isolation cut 27 without the saw blade 25 coming in contact with the barrier 12.

The size of the vacuum apertures 11 and the distance between barriers 12 across the vacuum aperture 11 is dependent on the size of semiconductor devices being processed. For singulating square semiconductor devices, the distance between the barriers 12 is generally about the same as the size of the semiconductor devices, and the vacuum apertures 11 are smaller than the semiconductor devices. For example, in one embodiment, the semiconductor devices are 4 mm square, the barriers 12 are about 4 mm apart and the vacuum apertures are less than 4 mm across. In a further embodiment, the semiconductor devices are less than 4 mm square, the barriers 12 are less than 4 mm apart and the vacuum aperture is less than 4 mm across. In another embodiment, the semiconductor devices are 1 mm square, the barriers 12 are about 1 mm apart and the vacuum aperture is less than 1 mm across.

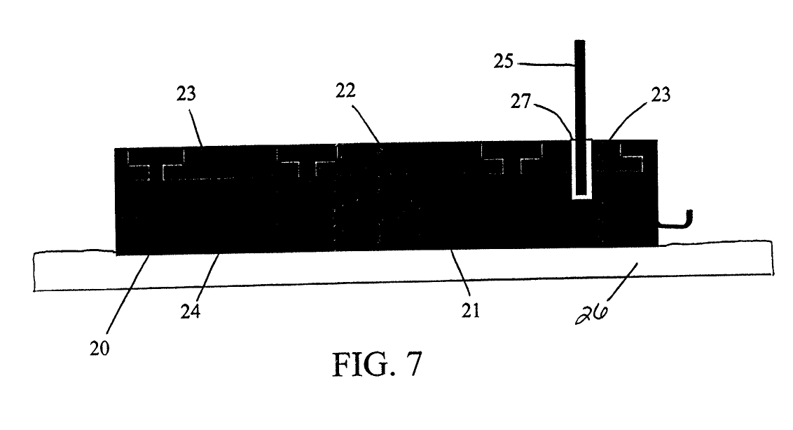

Referring now to FIGS. 7-11 the steps involved in the present semiconductor device singulation method are illustrated. The first step in the singulation method involves making isolation cuts in the strip to isolate each semiconductor device. The isolation cuts completely surround each semiconductor device, but do not penetrate all the way through the strip. The isolation cuts may be made in either the top or bottom of the strip, but are generally made in the bottom to facilitate testing of the individual semiconductor devices prior to making the singulation cut. As used herein, the “bottom” of the strip of semiconductor devices refers to the exposed pad or termination side, and the “top” refers to the mold cap side. For a strip in which the individual semiconductors are arranged in a grid of columns and rows, a first isolation cut is generally made along one axis (columns or rows). The saw then rotates 90 degrees and a second isolation cut is made along the other axis. In an alternative embodiment, the saw may remain fixed, and the support or chuck carrying the strip of semiconductor devices may move and rotate to facilitate the cutting process.

Saws with one or a plurality of blades may be used. In a saw comprising a plurality of blades, the blades are located on one or more spindles, and are configured to cut between the semiconductor devices. In one embodiment, for cutting rectangular shaped semiconductor devices, the saw comprises multiple spindles, each spindle having multiple blades. The spacing between blades on one spindle corresponds to the short side of the rectangular semiconductor device, and the spacing between blades on a second spindle corresponds to the long side of the rectangular semiconductor device. Other configurations of spindles and blades are used for cutting corresponding shaped semiconductor devices.

While the illustrated embodiment is described as being cut with a saw, it will be understood that alternative cutting mechanisms, such as lasers, water jets and other suitable semiconductor device cutting mechanisms can be used.

FIG. 7 shows a cross-section of a strip of semiconductor devices 20 on a support 26 during an isolation cut. The strip of semiconductor devices 20 comprises a semiconductor die 21 with exposed die pad 22, leadframe 23 and mold compound 24. The saw blade 25 cuts into the leadframe just deep enough to remove the copper tie bars between the leads of the semiconductor devices. The isolation cuts 27 are generally made a minimum of 0.003 inches deeper than the thickness of the common conductive barrier between adjacent semiconductor devices. For example, the isolation cuts may be made to a depth of 0.015 to 0.025 inches.

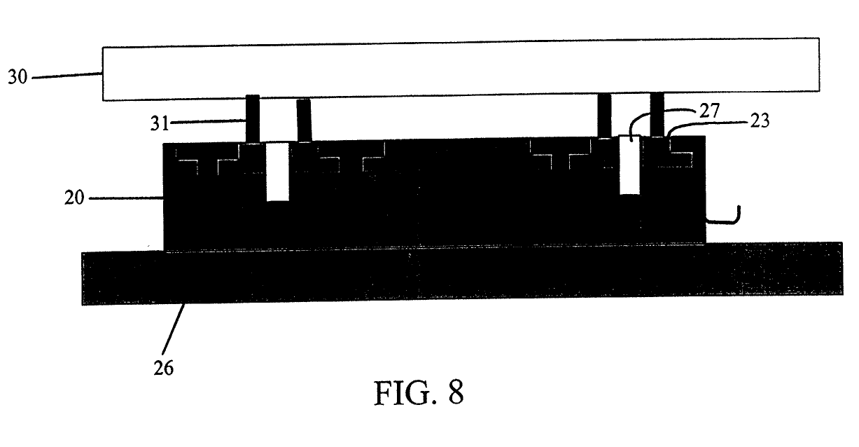

After the isolation cut is made, the strip of semiconductor devices may be inverted for the singulation cut, or the semiconductor devices may be tested. The testing may be performed with the strip on the support 26 used during the isolation cut, or the strip may be removed and placed onto a different supporting member. FIG. 8 shows a strip of semiconductor devices 20 with isolation cuts 27 during a testing step. The testing generally involves a contact board 30 with pins 31 located such that when the contact board 30 is brought into contact with the strip of semiconductor devices 20, the pins 31 touch the leadframe terminations to achieve electrical contact. The type of testing performed will be appropriate for the type and eventual use of the semiconductors, and will be readily apparent to one of ordinary skill in the art.

An electronic strip map may be created corresponding to the isolated semiconductor devices on the strip. It is known in the industry to create an electronic strip map through testing of the semiconductor strip prior to singulation of the individual semiconductor devices. For example, the integrated MCT Tapestry Strip Handler manufactured by Micro Component Technology is able to test a strip of semiconductor devices and create an electronic strip map which contains specific address (or location) information related to each specific semiconductor on the strip and further includes quality information (i.e., such as “good” or “bad”) for each semiconductor device on the strip based on the testing. The industry organization of Semiconductor Equipment and Materials International (SEMI) has promulgated draft standards relating to the creation of electronic strip maps for strips of semiconductor devices.

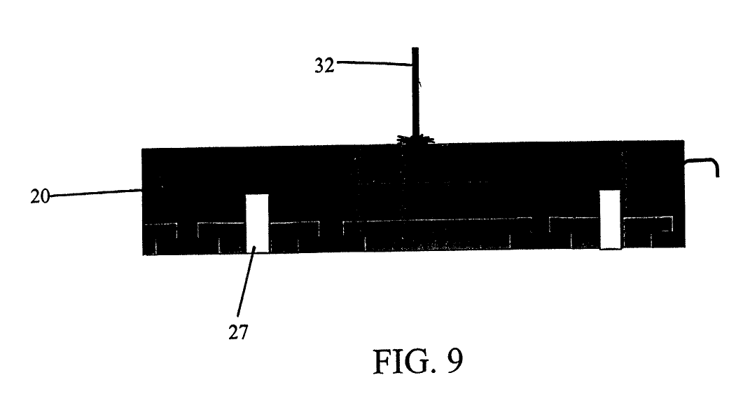

FIG. 9 shows the step of marking the semiconductor devices. After the strip of semiconductor devices 20 has received isolation cuts 27, the devices may be marked. If the semiconductor devices have been tested, the information marked on the devices may be a code reflecting the test results. Alternatively, a strip map may be recorded with the location and test result of each semiconductor device. The semiconductor devices are generally marked on the “top” or mold cap side. The marking may be done by a laser 32 or ink. In order to mark the mold cap side, the strip of semiconductors may be inverted onto another support, or the saw chuck.

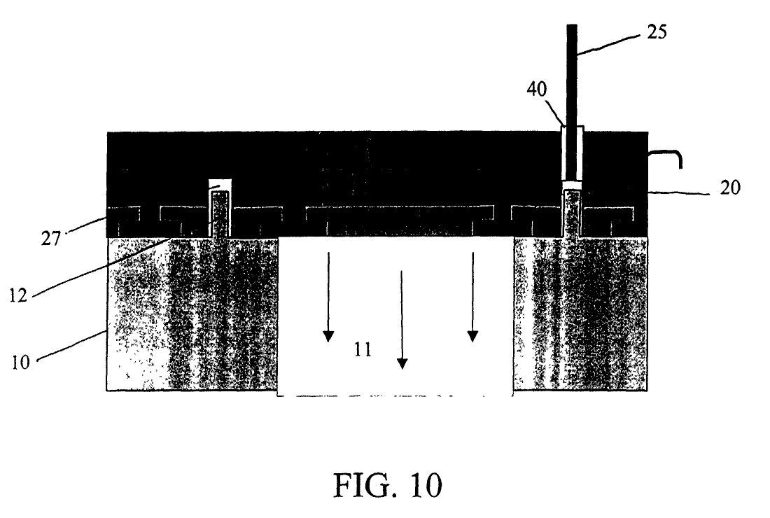

FIG. 10 shows the step of making a singulation cut. After the isolation cuts 27 are made, and after any testing and/or marking steps, the strip of isolated semiconductor devices 20 is placed onto a singulation saw chuck 10. A vacuum source is connected to the vacuum apertures 11 and turned on. The isolation cuts 27 mate with the barriers 12 to help retain the strip of semiconductors in position for cutting. The strength of the vacuum is such that the strip of semiconductor devices is secured to the saw chuck 10. In one embodiment, the vacuum is between 10-30 inches of mercury. In one embodiment, the vacuum is 30 inches of mercury. The combination of the barriers 12 and the vacuum maintains the semiconductors in their original positions during and after the singulation cuts 40 are made. The vacuum may be a positive vacuum, a venturi vacuum, or the vacuum may be created by any other suitable means.

The saw blade 25 is positioned directly above an isolation cut 27 and is adjusted such that the blade cuts completely through the strip of semiconductor devices 20 and into the isolation cut 27, but does not impinge on the barrier 12, thereby completing the singulation of individual semiconductor devices.

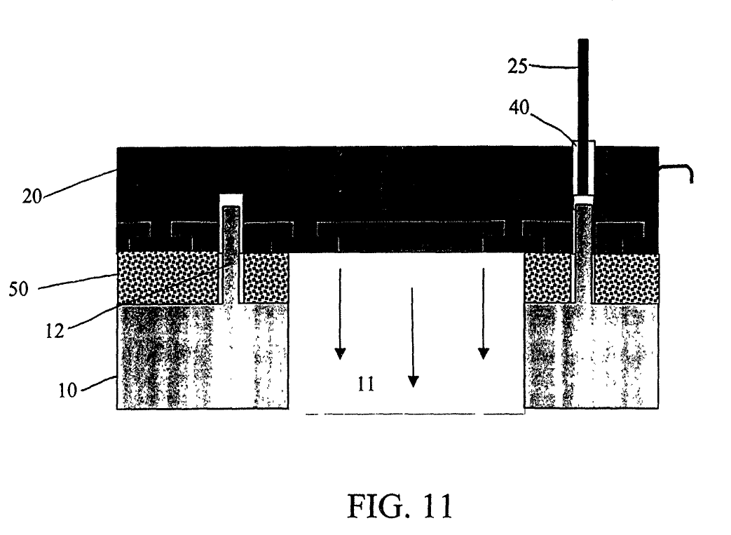

FIG. 11 illustrates another embodiment in which compliant material 50 is placed on the saw chuck 10, with the barriers 12 protruding through. The compliant material acts as a cushion between the saw chuck and the semiconductor devices and protects the termination side of the semiconductor devices during the singulation step. The compliant material also provides a seal between the saw chuck and the strip of semiconductor devices to maintain the vacuum integrity. The compliant material may be formed from a soft, resilient material such as a gel, organic or inorganic elastomer such as silicone, foam or any other compliant material determined by one of ordinary skill in the art, upon reading the present disclosure, to be suitable.

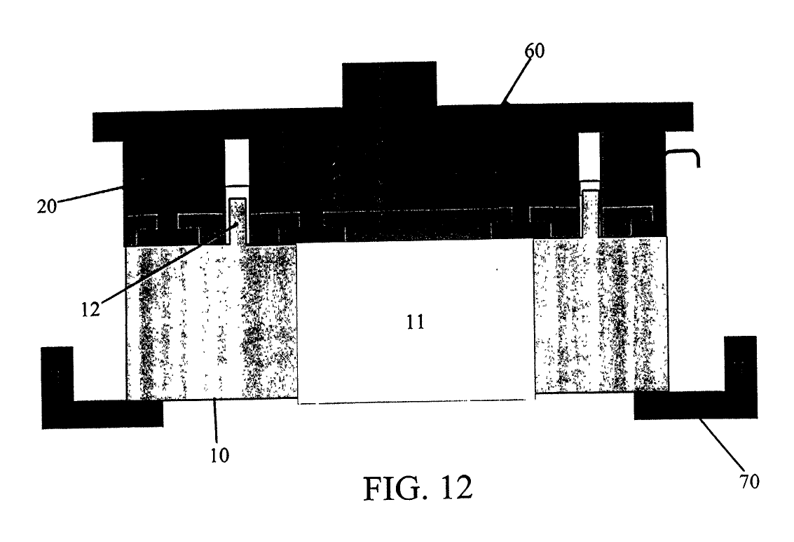

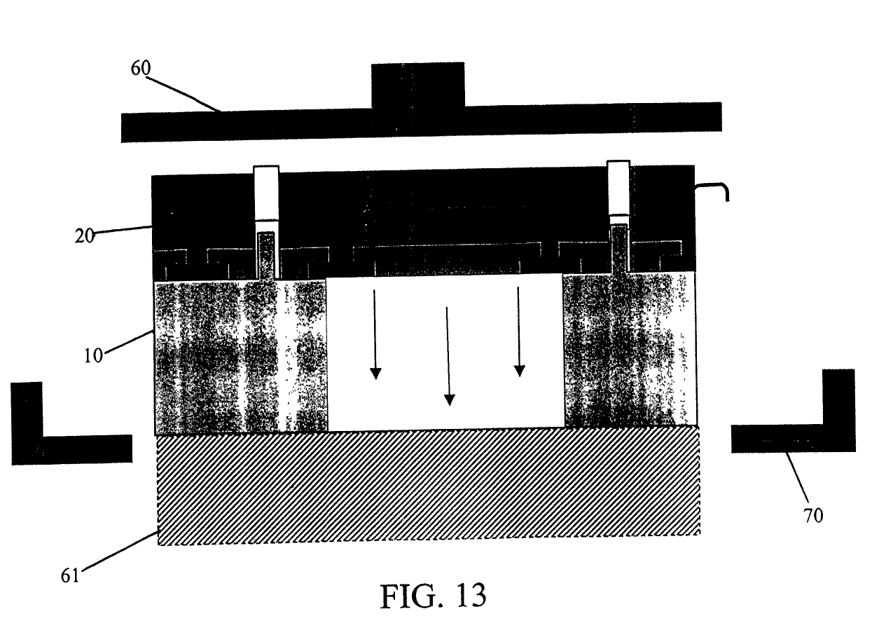

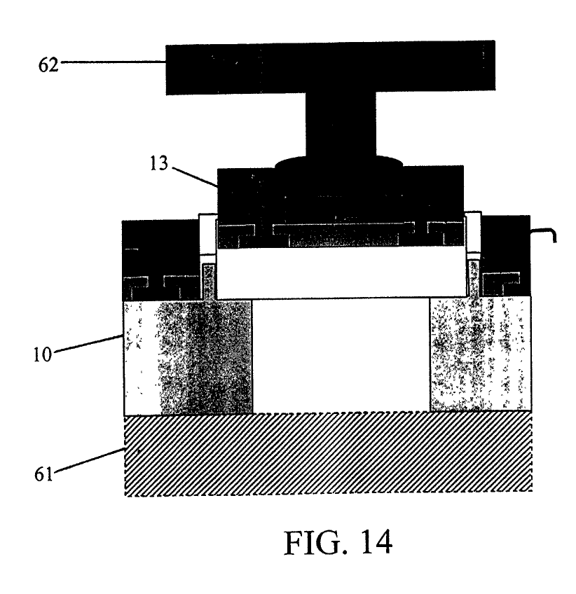

Since the barriers 12 retain the singulated semiconductor devices in their original positions, the saw chuck 10 may be used to transport the semiconductor devices to another location for further processing and/or sorting. FIGS. 12-14 illustrate transporting the individual semiconductor devices to a sorting device using the singulation saw chuck 10. Once the semiconductors are singulated, the vacuum from the singulation saw is turned off and the saw chuck 10 is removed from the saw using a carrier device 70. A cover plate 60 can be placed on top of the semiconductor devices to aid in holding them on the saw chuck 10, as shown in FIG. 12. FIG. 13 shows the saw chuck 10 with singulated semiconductor devices in place on a sorter apparatus 61 which has a vacuum source. The vacuum source is turned on and the cover plate 60 is removed. In one embodiment, the vacuum is turned off and a sorting mechanism 62 picks up selected semiconductor devices according to a strip map or other test results. See FIG. 14. It will be apparent to one of ordinary skill in the art that the semiconductor singulation apparatus and saw chuck may be used with a variety of sorting apparatus and methods.

Another aspect of the invention is an apparatus for singulating semiconductor devices from a strip containing multiple semiconductor devices. The apparatus includes a support member adapted for holding a strip of semiconductor devices for the isolation cut. The support may be a saw chuck without barriers, or any other suitable carrier. The apparatus additionally includes a transfer mechanism and a saw chuck with upwardly extending barriers. The transfer mechanism is adapted to transfer a strip of semiconductor devices that have had singulation cuts made in them from the support to a saw chuck with barriers. The transfer mechanism inverts the strip of semiconductor devices such that the isolation cuts mate with upwardly extending barriers on the saw chuck. The saw chuck may have vacuum apertures located between the upwardly extending barriers. The apparatus additionally includes a cutting mechanism, which may be a saw, laser, water jet, or other suitable mechanism for cutting semiconductor devices. The apparatus may involve a semiconductor testing device and/or a marking device.

The present method and apparatus can be used with a variety of singulation devices. One such singulation system is the integrated MTI NSX250DS dual spindle singulation system.

The saw chuck may include side mounting holes and end holes to assist in moving and mounting the chuck. Alignment holes may be positioned through a portion of the saw chuck for securing the device to a singulation saw. Since the saw chuck maintains the semiconductor devices in their strip orientation, the saw chuck may be used to transfer the semiconductor devices to a sorting apparatus.

The above disclosure provides a complete description of the methods, devices and apparatus of the invention. Since many embodiments of the invention can be made without departing from the spirit and scope of the invention, the invention resides in the claims hereinafter appended.

We claim:

1. A saw chuck for holding a strip of semiconductor devices, comprising:
a top and a bottom surface;
a plurality of vacuum apertures extending through the chuck from the top to the bottom surface, said apertures being in fluid communication with a vacuum source;
a plurality of barriers on the top surface of the chuck, wherein one or more barriers are located adjacent each aperture.

2. The chuck of claim 1 wherein the barriers comprise pins.

3. The chuck of claim 1 wherein the barriers comprise walls.

4. The chuck of claim 1 wherein the apertures are arranged in columns and rows forming a grid, wherein each aperture is positioned in a separate grid square.

5. The chuck of claim 4 wherein the barriers comprise cross-shaped walls positioned at junctions between columns and rows.

6. The chuck of claim 4 wherein the barriers comprise L-shaped walls positioned at junctions between columns and rows.

7. The chuck of claim 4 wherein the barriers comprise walls positioned at least part way along lines defined by the columns and rows.

8. The chuck of claim 7 wherein the walls extend the entire length of lines defined by the columns and rows such that each aperture is completely surrounded by walls on four sides.

9. The chuck of claim 1 further comprising a layer of compliant material on the top surface.

10. The chuck of claim 1 wherein the barriers have a height between 0.010 and 0.020 inches.

11. A method for singulating a semiconductor strip comprising a plurality of semiconductor devices having a common conductive barrier between adjacent semiconductor devices, the method comprising:
performing isolation cuts on the semiconductor strip, wherein the isolation cuts are made between individual semiconductor devices and the cuts extend part way through the strip;
placing the semiconductor strip on a saw chuck, wherein the saw chuck comprises a top and a bottom surface and at least one upwardly extending barrier on the top surface, the strip being positioned such that the barriers mate with the isolation cuts, wherein the barriers are of a height such that they do not extend all the way into the isolation cuts; and
performing singulation cuts, wherein the singulation cuts are made directly above the isolation cuts and extend to the level of the isolation cuts such that each semiconductor device is separated from the strip.

12. The method of claim 11 wherein the saw chuck further comprises a plurality of vacuum apertures, the vacuum apertures located adjacent the barriers, wherein the semiconductor strip is positioned on the saw chuck such that the semiconductor devices are positioned over the vacuum apertures; wherein the method further comprises the step of activating a vacuum after the strip of semiconductor devices is placed on the chuck.

13. The method of claim 11 further comprising the step of testing the semiconductors after performing isolation cuts.

14. The method of claim 13 further comprising the step of marking the semiconductors after the testing step.

15. The method of claim 11 wherein the strip of semiconductor devices comprises a top surface comprising mold compound, and a bottom surface comprising leadframe material, wherein the isolation cuts are made through the leadframe on the bottom, and the singulation cuts are made through the mold compound on the top.

16. The method of claim 11 wherein each semiconductor device is less than 4 mm square.

17. The method of claim 11 wherein the common conductive barrier between adjacent semiconductor devices is at a substantially uniform depth, wherein the isolation cuts are made at least 0.003 inches deeper than the thickness of the common conductive barrier between adjacent semiconductor devices.

18. The method of claim 11 wherein the isolation cuts are made to a depth of about 0.015 to 0.025 inches.

19. The method of claim 14 wherein each semiconductor device is marked with a code providing the test result of the semiconductor device.

20. The method of claim 14 wherein an electronic strip map is created providing the location and test result of each semiconductor device.

21. The method of claim 11 wherein the isolation and singulation cuts are made by a saw.

22. The method of claim 11 wherein the isolation and singulation cuts are made by a laser.

23. The method of claim 11 wherein the isolation and singulation cuts are made by a water jet.

24. An apparatus for singulating semiconductor devices manufactured in a strip containing a plurality of semiconductor devices comprising:
a support member adapted to hold a strip of semiconductor devices;
a transfer mechanism adapted for inverting and moving the strip of semiconductor devices from the support to a saw chuck;
a saw chuck comprising a non-porous carrier comprising a top and a bottom surface, a plurality of vacuum apertures extending through the carrier from the top to the bottom surface, and a plurality of barriers on the top surface, wherein one or more barriers are located adjacent each aperture; and
a cutting mechanism.

25. The apparatus of claim 24 further comprising a semiconductor testing device.

26. The apparatus of claim 25 further comprising a semiconductor marking device.

27. The apparatus of claim 24 wherein the saw chuck further comprises a layer of compliant material on the top surface.

28. The apparatus of claim 24 wherein the barriers have a height of at least 0.001 inches less than the depth of the isolation cut.

29. The apparatus of claim 24 wherein the barriers have a height of between 0.010 and 0.020 inches.

30. The apparatus of claim 24 wherein the barriers are less than about 4 mm apart.

31. The apparatus of claim 30 wherein the barriers are about 1 mm apart.

32. The apparatus of claim 24 wherein the cutting mechanism is a saw.

33. The apparatus of claim 24 wherein the cutting mechanism is a laser.

34. The apparatus of claim 24 wherein the cutting mechanism is a water jet.
